(19) United States
(12) Patent Application Publication
(10) Pub. No.: US 2022/0012697 A1
(43) Pub. Date: Jan. 13, 2022

(54) INTERMEDIARY ADVANCED PAYMENT PROCESSES

(71) Applicant: UP N' GO, San Diego, CA (US)

(72) Inventor: Touradj Barman, San Diego, CA (US)

(21) Appl. No.: 17/369,932

(22) Filed: Jul. 7, 2021

Related U.S. Application Data
(60) Provisional application No. 63/049,094, filed on Jul. 7, 2020.

(51) Int. Cl. G06Q 20/02; G06Q 20/20; G06Q 20/32; G06Q 30/04; G06Q 20/28; G06Q 40/02; G06F 16/958

(52) U.S. Cl. CPC G06Q 20/02; G06Q 20/209; G06Q 20/322; G06Q 30/04; G06Q 20/326; G06Q 20/202; G06Q 40/02; G06F 16/958; G06Q 20/28

(57) ABSTRACT

Systems and methods are disclosed for using an advance payment intermediary to accept advance payments at a point of sale device without the point of sale device having a relationship with an advance payment system. For example, a method may include: reviewing a point of sale database having a plurality of restaurant checks for a first restaurant check having a field with an entry that includes a phone number; retrieving from the point of sale database the amount associated with the first restaurant check and the phone number associated with the first restaurant check; creating a webpage that includes details of the first restaurant check having the payment amount associated with the first restaurant check and a one or more payment fields; creating a link to the webpage; and sending the link to the phone number.

### SUMMARY

Some embodiments include a method and/or a system for executing the method comprising: receiving a request for an advanced payment at a payment intermediary that includes a payment amount and a check number. The payment intermediary may be a device (or webpage or application or app etc.) that is separate and distinct from a point of sale device (e.g., restaurant POS). A request for payment may be sent by the payment intermediary to an advanced payment processor and an authorization amount. The authorization amount may be the same or more than the payment amount. An authorization message may be received at the payment intermediary. Credit card data can be sent to the restaurant POS with the payment amount (possibly minus a transaction fee) and the check number. At some point the payment intermediary may settle the transaction with the advance payment processor and/or the restaurant may settle the credit card transaction with the credit card processor. In some embodiments, the advanced payment method include Apple Pay®, Google Pay, Venmo, PayPal, Zelle, Cash App, or crypto currency.

In some embodiments, if the credit card transaction fails (e.g., is not authorized for whatever reason), the payment intermediary may provide a different credit card for processing.

In some embodiments, a user can view a check (or bill) at a third-party webpage (e.g., not associated with a restaurant, merchant, vendor, bank, or point of sale device). The check can be associated with a restaurant ID and/or check ID and/or may list items included on the check and/or an amount due, etc. The third-party webpage may provide a field that allows a user to select a tip, select specific items on the bill to pay for, and/or may provide an indication of the total amount they want to pay. The third-party webpage may present a list of ways for the user to pay the check including one or more Advanced Payment Methods (APMs) such as, for example, but not limited to Apple Pay®, Google Pay, Venmo, PayPal, Zelle, Cash App, crypto currency, etc.

If the guest selects an APM for payment, the third-party webpage may send the user to an environment of the selected APM (the “APM Environment”) such as, for example, an app or a popup window, or a webpage associated with the APM, etc. For example, if the user selects Venmo as the APM, the user may be sent to the Venmo app or if the user selects Apple Pay® then the device's native Apple Pay® environment (e.g., a popup) may be displayed. The APM Environment, for example, may also be provided the identity of the third-party webpage as the payment recipient and/or for identity proof. The APM Environment, for example, may also be provided with an authorization amount.

Apple Pay® in the APM Environment, the user can approve the payment. The APM Environment may send the third-party webpage a transaction authorization or a transaction denial. If the APM denies the transaction, the third-party webpage may provide the info to the user via the third-party webpage and/or may provide other payment options to the user.

If the APM gives authorizes the payment, then the third-party webpage may attempt to pay a point of sale device using a credit card associated with the third-party webpage (the “Intermediary Credit Card”). The POS may send an credit card authorization to the credit card issuer. At this point, the credit card payment attempt may succeed or fail (for a variety of reasons). If it fails, then the third-party webpage may void or cancel the APM charge. A corresponding message may be presented to the guest via the third-party webpage that the payment didn't succeed and/or may provide other payment options to the user.

If the credit card payment returns with an authorization, then the APM charge may be settled and/or display to the guest via the third-party webpage that indicates that the payment was successful and/or include the payment amount. The credit card charge may also be settled either individually or as part of a batch.

Any number of related activities can also be initiated, like emailing or texting receipts, sending payment data to one or more other systems, logging loyalty points, transaction history, etc.

Some embodiments include a method and/or a system for executing a method comprising: reviewing a point of sale database having a plurality of restaurant checks for a first restaurant check having a field with a mobile phone number (e.g., consecutive digits representing a mobile phone number) or representation or reference related to a mobile phone number. The method may also include creating a link that would lead to the that check when selected by a user and/or texting that link along with any related language to that mobile phone number.

In some embodiments, the data base field may include any kind of database field. The database field, for example, may or may not be a field specifically designed to contain a phone number. The database field, for example, may or may not be a field which may or may not have been a previously agreed upon field for a phone number. The database field, for example, may include a tab name or an item on a check with or without a predesignated name like “CONTACT” that contains in or related to it, such as within a description area.

Some embodiments may also include, creating a webpage that includes details of a restaurant check having a mobile phone entry; creating a unique link to the webpage; and sending the unique link to the mobile phone entry.

In some embodiments, the details of a restaurant check include one or more menu items, a total check amount, a credit card payment field, and/or an advanced payment button or field

The various embodiments described in the summary and this document are provided not to limit or define the disclosure or the scope of the claims.

### BRIEF DESCRIPTION OF THE FIGURES

FIG. 1 is a block diagram of a credit card processing system according to some embodiments.

FIG. 2 is a block diagram of an APM processing system according to some embodiments.

FIG. 3 is a block diagram of a computational system that can be used to with or to perform some embodiments described in this document.

FIG. 4 is a process for using texting a check to a user such as, for example, at a restaurant.

FIG. 5 is a process for using an advance payment intermediary to accept advance payments at a point of sale device without the point of sale device having a relationship with an advance payment system.

FIG. 6 is a process 600 for using an advance payment intermediary to accept advance payments at a point of sale device without the point of sale device having a relationship with an advance payment system and may not accept direct advance payments.

### DETAILED DESCRIPTION

Many merchant point of sale (POS) systems are capable of accepting credit card payments. These POS systems can often accept a credit card via swipe, keyed, or API or some other electronic insertion. Then they send the credit card to an acquirer, gateway, network, and/or processor for authorization and/or settlement. A “credit card” may mean credit card data including but not limited to any of a credit card number, expiration date, CVV or other security code, cardholder name, address or part thereof, etc.

An Advanced Payment Method (APM) may include any type of payment system that is different than credit card payments and may include but are not limited to Apple Pay®, Google Pay, Venmo, PayPal, Zelle, Cash App, crypto currency, and many, many more.

Most POS systems cannot accept APM. However, many businesses that use POS systems desire to accept one or more APMs.

It can be very difficult for businesses to accept APM and also maintain all transaction tracking in their POS systems. Sometimes it is not possible and creates more accounting work for businesses if they want to accept APM outside of their POS. Sometimes APM can be partially tracked within their POS using what are called tenders, essentially accounts that say payments were made using certain methods.

Some businesses may buy or rent hardware or use apps on external mobile devices to accept one or more APM. This creates more hardware and software needs for businesses and more accounting work and systems that do not track all transactions together well. Often this set up is extremely complex and expensive and requires specialized technology skills to set up. Access to these skills can be limited, expensive, and inconvenient.

Sometimes and most often, businesses may need to acquire additional payment processors to accept APM. So a business may need to change or add vendors in the form of additional payment processors. This is often not desired for many reasons.

In some embodiments, an APM intermediary authorizes an APM payment initiated from a user. The APM intermediary may then pay the restaurant via a credit card. If the APM intermediary can successfully pay the restaurant's system with its credit card, then it settles the APM payment from the guest. If the APM intermediary can't pay the restaurant (for any reason) such as, for example, if the credit card processing system is experiencing some error or unavailability, the APM intermediary may void the APM authorization and/or notify the guest of this and related details.

There are many additional inefficiencies created or inabilities present for businesses to accept APM.

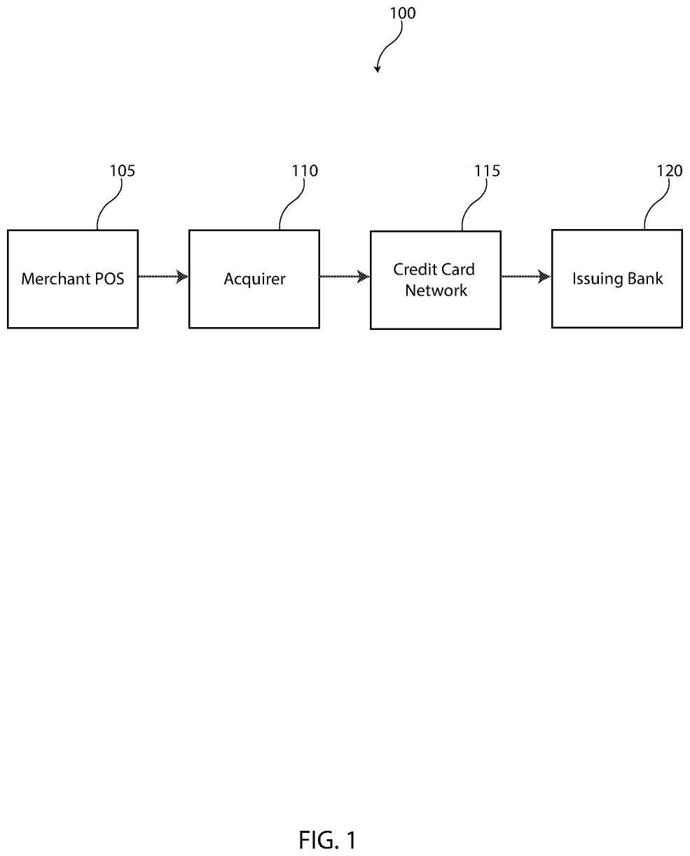

FIG. 1 is a block diagram of a credit card processing system 100 according to some embodiments. Credit card payment and process my occur in three stages. The first stage can include purchase authorization. The merchant POS 105 may include a point of sale device that collects credit card data from a customer. The merchant POS 105 communicates the credit card data to the acquirer 110. The acquirer 110 forwards the credit card details to the credit card network 115. The credit card network 115 clears the payment and requests payment authorization from the issuing bank 120. The authorization request includes the following: the credit card number, the card expiration date, the billing address, the card security code (e.g., CVV), and payment amount.

The second stage of the process can include authentication. The issuing bank 120 may verify the validity of the customer's credit card using fraud protection tools (e.g., using the Address Verification Service (AVS) and card security codes such as CVV, CVV2, CVC2 and/or CID). The issuing bank 120 may also receive the payment authorization request from the credit card network 115. The issuing bank 120, for example, may validate the credit card number, checks the amount of available funds, matches the billing address to the one on file and validates the CVV number. The issuing bank 120 can approve or decline the transaction and sends back the appropriate response to the merchant POS 105 through the same channels such as, for example, the credit card network 115 and/or acquiring bank or processor.

Once the merchant POS 105 receives the authorization, the issuing bank 120 can place a hold in the amount of the purchase on the cardholder's account. The merchant's POS terminal can collect all approved authorizations to be processed in a “batch” at the end of the business day. The merchant POS 105 provides the customer a receipt to complete the sale.

The third stage may include clearing and settlement. In the clearing stage, the transaction may be posted to both the cardholder's monthly credit card billing statement and the merchant's statement. It can occur simultaneously with the settlement stage.

At the end of each business day, the merchant POS 105 can send the approved authorizations in a batch to the acquirer 110. The acquirer 110 can route the batched information to the credit card network 115 for settlement. The credit card network 115 can forward each approved transaction to the appropriate issuing bank 120. Usually within 24 to 48 hours of the transaction, the issuing bank 120 may transfer the funds less an “interchange fee,” which it shares with the credit card network 115.

The credit card network 115 can pay the acquiring bank and the acquirer 110 the respective percentages from the remaining funds. The acquirer 110 credits the merchant's account for cardholder purchases, less a “merchant discount rate.” The issuing bank 120 can post the transaction information to the cardholder's account. The cardholder can receive the statement and pays the bill.

In some embodiments, situations the merchant POS may not be capable of collecting advanced payment methods (APM). APM may include any kind of electronic payment methods other than credit cards such as, for example, Apple Pay®, Google Pay, Venmo, PayPal, Zelle, Cash App, crypto currency, etc., etc.

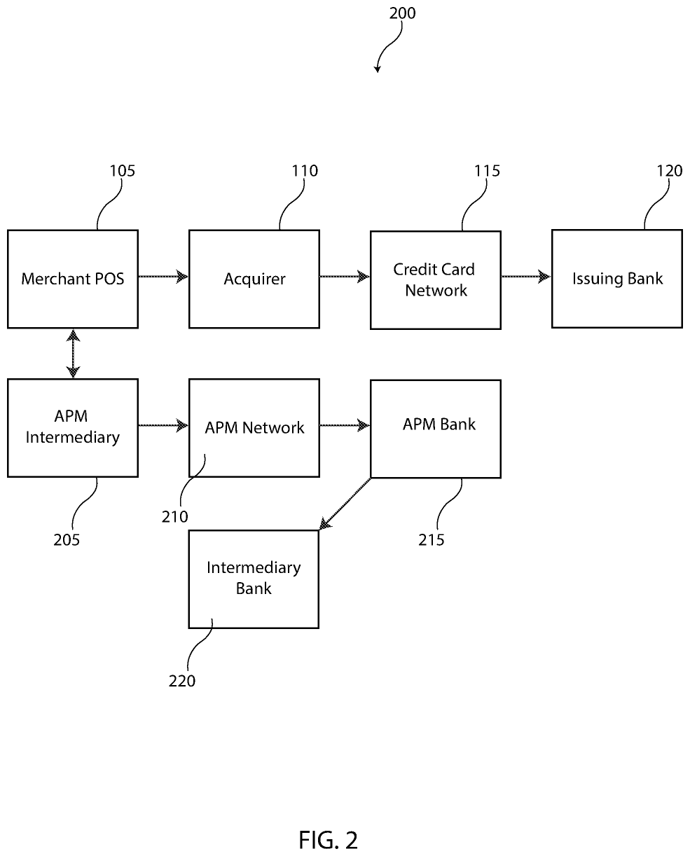

FIG. 2 is a block diagram of an APM processing system 200 according to some embodiments. Payments may be made at the merchant using an APM intermediary 205. The APM intermediary 205 may take on any number of devices or methods.

The customer can view or receive a bill (or check) from a business via the APM intermediary 205. The business or the POS can send bill data to the APM intermediary 205. The customer can make the payment at the APM intermediary 205 using APM. The APM intermediary 205 can send payment authentication, authorization, and/or requests via the APM network 210 and/or receive funds from the APM Bank 215.

Once the APM intermediary 205 confirms availability and/or receipt of payment from the customer via the APM intermediary 205, the APM intermediary 205 can send credit card information to the merchant POS 105 for processing using the business's standard credit card process.

For example, a customer at a restaurant can receive a check for dinner service for a check amount. The check may include a check number. The customer may wish to pay the check using Apple Pay® even though the restaurant merchant may not directly accept Apple Pay®. The customer may, however, pay with Apple Pay® (or any other APM) via the APM intermediary 205. The APM intermediary 205 may receive Apple Pay® payment information from the customer including the check number and send it to the APM network 210. The APM network 210 may send a request for Apple Pay® payment to the APM Bank 215 in the amount of $50. The APM Bank 215 may authenticate and/or authorize payment to the restaurant via the APM intermediary 205. Funds may be transferred to the APM intermediary 205 using the Apple Pay® processes and/or protocols at any time such as, for example, through a settlement function. Funds in the amount of the check amount (minus any fees) may be deposited into the intermediary bank 220.

The APM intermediary 205 may send an intermediary credit card information, the check number, and the check amount to the merchant POS 105. The merchant POS 105 may process the intermediary credit card for the check amount as per process 100. The check amount may be charged to the intermediary credit card and funds equal to the check amount (e.g., optionally minus any fees) may be deposited in the restaurant bank account. In some embodiments, fees may be collected later also such that the dollar amount paid to the intermediary via APM equals the dollar amount paid to the restaurant via the intermediary's credit card. In some embodiments, the intermediary may separately bill the restaurant for any associated fees.

In some embodiments, the APM intermediary 205 may send the credit card information to the merchant POS 105 before, at the same time, or after the APM transaction is processed.

In some embodiments, the APM intermediary 205 may send the credit card information to the merchant POS 105 with the check amount (e.g., minus an administrative fee). Sometimes the APM intermediary can send the same amount to the restaurant and charge any fees to the restaurant later such as, for example, on a monthly invoice.

In some embodiments, the APM intermediary 205 may send one or more tenders to the merchant POS 105. The tenders may or may not carry any information about the original transaction, e.g. one tender could be “INTERMEDIARY-APPLE-PAY-VISA” and another tender could be “INTERMEDIARY-VENMO,” where the term INTERMEDIARY may include the name of the intermediary (e.g., “UPNGO”).

In some embodiments, the APM intermediary 205 may send the credit card information to the acquirer 110 or the credit card network 115. This may make it possible to not send credit card numbers to the restaurant POS directly, which may relieve the restaurant of PCI and/or other information security and privacy burdens.

In some embodiments, the customer may pay for a portion of a bill or check using APM. Other portions may be paid in any other method.

In some embodiments, the APM intermediary 205 may send a virtual credit card number to the merchant POS 105. The virtual credit card number can be tied to a specific payment for tracking purposes.

In some embodiments, if a restaurant (or any merchant) performs a refund to a virtual card number, our system can recognize which original payment that virtual card number was used for and then automatically apply a corresponding refund to the original payment method since records stored in one or more databases will be able to determine the linkage.

Some embodiments include the ability to automatically send a text message to a guest that contains a link to view and pay a bill or check.

In some embodiments, a restaurant can enter a mobile phone number (or a number or other code corresponding to a mobile phone number) in any part of the check details or other areas in a restaurant POS system. For example, but not limited to, a restaurant might open a tab in their POS and/or in the field to name a tab, enter a mobile number; or a restaurant might add a $0 or non-$0 menu item with a description that contains a mobile number or reference to a mobile number. In addition, any other communications ID (e.g., email, messenger ID, WhatsApp Id, etc.) on any communications platform could also be entered. The item could have a specific name or not. If the communications ID has a specific name, then system may react in any way to the specific name and number or communications ID, decided if and how to act upon it.

In some embodiments, the system or process may access the check database at the restaurant POS either periodically or in real time to find check data. If a mobile number or other communications ID associated with a check is detected, then a secure and/or unique payment link to the associated check can be created. The link may be texted to that mobile phone number (or send it via communications ID on a communications platform).

In some embodiments, the system can pull the mobile number from a related system via an API or other method. For example, if an online ordering system was involved in sending the order to the restaurant POS, the restaurant POS may not have the guest's mobile number, but the system could obtain the guest's mobile number from the online ordering system and link that number to the given check.

In some embodiments, for example, a guest can place an order with a restaurant, make their mobile number known, the restaurant can enter the guest's mobile number in or associated with the check or tab data in their POS, the system can search this data, associate the mobile number with the specific check number and that specific restaurant, generate a URL that identifies that check and text it to the mobile number. Upon clicking that URL, the guest can be taken to the unique website with the check or app where they can view and pay their check.

In some embodiments, certain codes or phrases or menu items can subsequently be added to a check to perform different actions. For example, a restaurant could add a $0 or non-$0 item to or associated with a check called “Ready.” The system could detect that that item was added to the check and take a corresponding action, such as sending a subsequent text (or message via communications ID on a communications platform) notifying the guest that their food is ready for pick-up or will be delivered soon.

In some embodiments, a guest could reply to a text or communications send on a communications platform and say a keyword or word or phrase that can be interpreted, such as “Here” and then the system can send a corresponding message to the restaurant's POS or other communications system notifying them that the guest has arrived at the restaurant to pick up their food, for example.

Some embodiments may make it possible to passively add new communications functionality to restaurant POS systems that don't already have such functionality. This invention could be applied to other computing systems also and is not limited to restaurant POS systems. As one non-limiting example, this invention could be applied to a facility management software program, or any other computer system.

This system could work in other industries and not just be limited to restaurants. For example, mobile numbers and bills could be taken from any software system, such as one used at a hotel, at a self-storage facility, etc. The system can, for example, see how much an account owes in that system, determine the mobile number associated with that account, then text a link to that mobile number to display the amount owed.

A device could broadcast its mobile number to a system that manages amounts due and payments, for example, at a gas pump, a device such as a phone could be held near the pump and via a transmission from the phone perhaps if the phone is within a certain distance of another device, the phone number can be determined and associated with that gas pump and then a link to pay the amount due for the gas could be texted to the phone. The link could be clicked, the check viewed, and then payment submitted. This could also occur in a store when making payments.

It is also possible to not need a separate system such as a POS, and to allow any amount or line items that each have an associated dollar amount or value associated with them to be aggregated to individually existing to then have a mobile phone number entered for them and then a link sent to that mobile number that allows the recipient to view and/or pay their check. In other works, the system can be its own POS and accept mobile numbers associated with checks and then send texts with links to pay those checks. In some embodiments, a POS can send links to view and pay checks to a mobile number.

Amounts owed may be showed via line items and not just one final amount. This way the guest can see their check and what they ordered that added up to the amount due including any associated taxes, surcharges, discounts, partial payments of other forms, etc.

Any other communications channel or ID could be substituted for a phone number or mobile phone number at any one or more steps of this process. For example, a user ID on a messaging service like Facebook Messenger, Slack, Google Chat or any other could be shared and then a link to view and pay the check or amount due sent to that user via that ID and that communications channel, system or network.

When a customer payment method (e.g., either a credit card, debit card, or advanced payment) is sent to a restaurant payment system (e.g., point of sale, APM intermediary, etc.), it could be possible for the restaurant payment system to identify the BIN number or other information of the incoming payment and determine the related interchange cost. If the interchange meets a certain criteria of any determination at any time (e.g., the interchange fee is more or less than an interchange fee associated with an intermediary credit card, the interchange fee is more or less than an interchange threshold, etc.), then the restaurant payment system could determine to either send the customer payment method to the merchant, or the restaurant payment system can accept payment from the customer payment method as the merchant and then sent an intermediary credit card or other payment method to the restaurant. Revenue, for example, can be generated by the payment intermediary (or POS) accepting payments that cost less to accept (e.g. low credit card interchange fees) and then making payments to restaurants or other retailers, merchants, or entities that pay back via cash back gained from interchange fees of those payment methods (pay with methods that have high interchange fees).

This may be referred to as “interchange swap” where an arbitrage exists between accepting payment via credit cards that have low interchange fees and replacing them with credit cards that have higher interchange fees. The intermediary has to pay the low interchange fees to accept a payment and then can participate in the higher interchange fees derived from paying the restaurant or other recipient with a card that has a higher interchange fee. This could have the effect of providing a revenue stream that allows an intermediary to fund its operations and not have to otherwise charge the restaurant or other merchant for its services, giving the perception that its service is “free,” which may be desirable to many customers.

Some embodiments may include using virtual card numbers as a means of tokenization.

It can be safer for a restaurant (or any merchant) to not accept credit cards because there the restaurant may be liable if the credit card information is stolen or misused by the restaurant. Many restaurants would prefer a program that keeps card numbers off their system, but those are expensive and inconvenient.

In some embodiments, a payment intermediary can intercept all credit card numbers by acting as intermediary (e.g., acting as the “merchant in the middle”) and then send virtual card numbers to restaurant payment systems (e.g., POS). The virtual card numbers can have many controls and limitations that render a virtual credit unusable if stolen.

These controls and/or limitations may include: one time use, use within a period of time after the it has been generated, use with a certain merchant only, use in a given merchant category only, use for a specified dollar amount (including or not including tip) only, use for a range of dollar amounts or below a certain dollar amount, etc. and any combination of these or other controls and limitations

The result is that a restaurant (or any merchant) that can use a payment intermediary that takes credit cards can continue to “take credit cards,” but not be taking credit cards if any reuse and limited misuse value, this effectively be “not taking credit cards” from a liability perspective.

Some embodiments may also include utilizing a virtual credit card number as a reference to a transaction (or another ID that can identify that transaction). For example, a customer may pay a transaction using APM via a payment intermediary and the payment intermediary may pay the restaurant (or a merchant) using a virtual credit card number that includes use limitations such as, for example, limited to a time window, limited to a specific transaction amount or range, etc. At some point, the restaurant may need to refund a portion or all of the transaction. The restaurant may process the refund from the virtual credit card. The payment intermediary may receive the refund for the virtual credit card, identify the payment with the APM transaction based on the payment limitations, and then process a refund via APM.

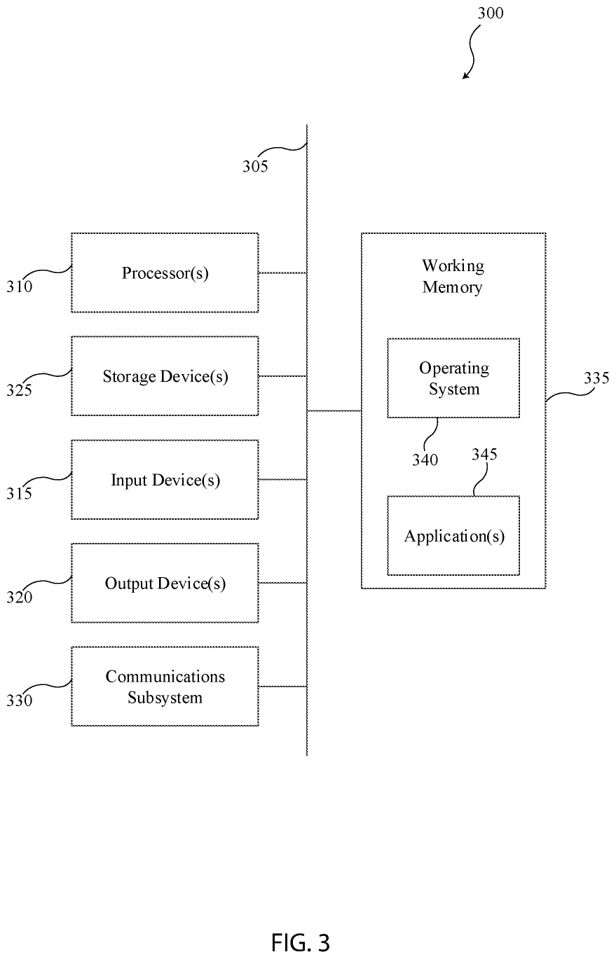

The computational system 300, shown in FIG. 3 can be used to perform any of the embodiments of the invention. For example, computational system 300 can be used to execute any processes described in this document. As another example, computational system 300 can perform any calculation, identification and/or determination described here. Computational system 300 includes hardware elements that can be electrically coupled via a bus 305 (or may otherwise be in communication, as appropriate). The hardware elements can include one or more processors 310, including without limitation one or more general-purpose processors and/or one or more special-purpose processors (such as digital signal processing chips, graphics acceleration chips, and/or the like); one or more input devices 315, which can include without limitation a mouse, a keyboard and/or the like; and one or more output devices 320, which can include without limitation a display device, a printer and/or the like.

The computational system 300 may further include (and/or be in communication with) one or more storage devices 325, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 300 might also include a communications subsystem 330, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 330 may permit data to be exchanged with a network (such as the network described below, to name one example), and/or any other devices described in this document. In many embodiments, the computational system 300 will further include a working memory 335, which can include a RAM or ROM device, as described above.

The computational system 300 also can include software elements, shown as being currently located within the working memory 335, including an operating system 340 and/or other code, such as one or more application programs 345, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 325 described above.

In some cases, the storage medium might be incorporated within the computational system 300 or in communication with the computational system 300. In other embodiments, the storage medium might be separate from a computational system 300 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 300 and/or might take the form of source and/or installable code, which, upon compilation and/or installation on the computational system 300 (e.g., using any of a variety of generally available compilers, installation programs, compression/decompression utilities, etc.) then takes the form of executable code.

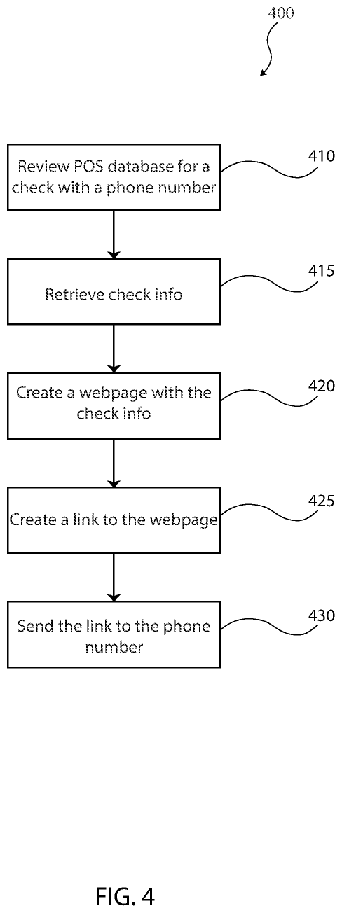

FIG. 4 is a process 400 for using texting a check to a user such as, for example, at a restaurant. Additional blocks, for example, may be added at any point in process 400. Some blocks, for example, may be removed or skipped. And the blocks, for example, may occur in any order.

At block 410 a point of sale database may be reviewed or scanned to find a check having a field with a phone number. A phone number may, for example, be in a field associated with a phone number or the phone number may, for example, be in any field within the database structure. The phone number, for example, may be entered by an employee taking an order. The search for the phone number may return a check number.

At block 415, the amount associated with the check number and the phone number associated with the check number may be retrieved from the point of sale database. Various other check details may be retrieved such as, for example, the items ordered and the cost of the items.

At block 420 a webpage that includes check details associated with the check number may be created. The webpage, for example, may include the total payment amount including taxes, fees, surcharges, etc. associated with the first restaurant check.

The webpage, for example, may include one or more payment fields that allow a user to pay the amount owed on the check when the webpage has been viewed by a user. The payment field, for example, may include a credit card payment field or an advanced payment field. The advanced payment field, for example, may include Apple Pay®, Google Pay, Venmo, PayPal, Zelle, Cash App, or crypto currency.

The webpage may also include options for the user to apply a tip to the transaction, make additional purchases, and/or enter apply a gift card or discount code.

At block 425, a unique link to the webpage may be created. The unique link, for example, may include a shortened URL.

At block 430, the unique link may be sent to the phone number associated with the first restaurant check via text message, messenger, SMS message, etc.

Alternatively or additionally, the phone number described in process 400 may be replaced with any other communication address or identifier such as, for example, an email address, Facebook ID, etc.

Alternatively or additionally, the process 400 may also receive an indication that the check amount has been paid by the user and make an entry in the point of sale database that the entry has been paid.

The process 400 may be repeated periodically such as, for example, every minute.

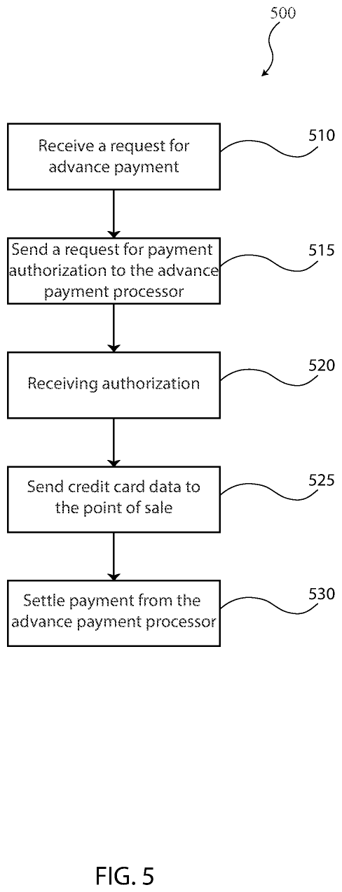

FIG. 5 is a process 500 for using an advance payment intermediary to accept advance payments at a point of sale device without the point of sale device having a relationship with an advance payment system and may not accept direct advance payments. Process 500 may allow the point of sale device to receive advance payments despite not having a relationship or directly being paid for the advanced payments. Additional blocks, for example, may be added at any point in process 500. Some blocks, for example, may be removed or skipped. And the blocks, for example, may occur in any order.

At block 510 an advance payment intermediary that is separate and distinct from the restaurant point of sale device may receive a request for an advanced payment that includes a payment amount, a check number, and/or a user identifier. The point of sale device, for example, does not accept direct advance payments.

At block 515, the advance payment intermediary may send a request for payment authorization to the advance payment processor. The request, for example, may include an authorization amount, the user identifier, username, password, etc. or other identifiers related to the advance payment intermediary. The request, for example, may be encrypted.

At block 520, the advance payment intermediary may receive from the advance payment processor a payment authorization for payment associated with the request.

At block 525 credit card data may be sent to the point of sale device from the advance payment intermediary with the payment amount and the check number. Alternatively or additionally, the advance payment intermediary may send an indication that that point of sale device should charge a specific credit card associated with the advance payment intermediary and/or saved on file with the point of sale device. Payment on the credit card may be processed through the point of sale device.

At block 530, payment from the advance payment processor for the authorization amount may be settled.

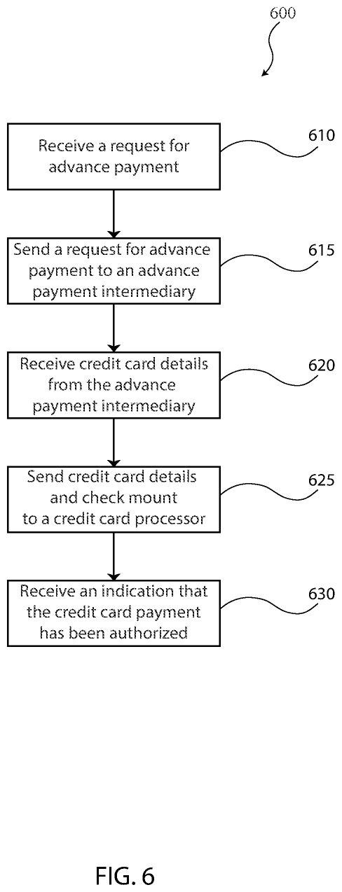

FIG. 6 is a process 600 for using an advance payment intermediary to accept advance payments at a point of sale device without the point of sale device having a relationship with an advance payment system and may not accept direct advance payments. Process 600 may allow the point of sale device to receive advance payments despite not having a relationship or directly being paid for the advanced payments. Additional blocks, for example, may be added at any point in process 600. Some blocks, for example, may be removed or skipped. And the blocks, for example, may occur in any order.

At block 610 a request for payment using an advance payment is requested at the point of sale device. The advance payment, for example, may be associated with a bill at a restaurant for a check amount. The request may include a user identifier and/or a check number. The request, for example, may also include the type of advance payment being requested.

At block 615 the point of sale can send a request for advance payment to an advance payment intermediary. The request may include a check amount, the user identifier, and/or the check number. The request, for example, may also include the type of advance payment being requested.

At block 620, the point of sale may receive credit card details from the advance payment intermediary for the check amount. The point of sale may also receive the check number.

At block 625, the check amount and the credit card details may be sent to a credit card processor.

At block 630, an indication from the credit card processor that credit card payment has been authorized may be received by the point of sale device. The point of sale device, for example, may change the status of the check from paid to unpaid.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

The terms “first”, “second”, “third”, etc. are used to distinguish respective elements and are not used to denote a particular order of those elements unless otherwise specified or order is explicitly described or required.

Numerous specific details are set forth to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained in software to be used in programming or configuring a computing device.

Embodiments of the methods disclosed may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. A method comprising:
reviewing a point of sale database having a plurality of restaurant checks for a first restaurant check having a field with an entry that includes a phone number;
retrieving from the point of sale database a payment amount associated with the first restaurant check and the phone number associated with the first restaurant check;
creating a webpage that includes details of the first restaurant check having the payment amount associated with the first restaurant check and a one or more payment fields that allow a user to pay for the first restaurant check when the webpage has been viewed;
creating a unique link to the webpage; and
sending the unique link to the phone number associated with the first restaurant check.

2. The method according to claim 1, wherein the details of the first restaurant check include one or more menu items.

3. The method according to claim 1, wherein the details of the first restaurant check include a total check amount.

4. The method according to claim 1, wherein the one or more payment fields includes a credit card payment field.

5. The method according to claim 1, wherein the one or more payment fields includes an advance payment field.

6. The method according to claim 5, wherein the advance payment field allows for payment using Apple Pay®, Google Pay, Venmo, PayPal, Zelle, Cash App, or crypto currency.

7. The method according to claim 1, further comprising receiving an indication that the first restaurant check has been paid.

8. The method according to claim 1, wherein the amount associated with the first restaurant check includes a transaction fee.

9. A method at an advance payment intermediary, the method comprising:
receiving from a restaurant point of sale device at an advance payment intermediary that is separate and distinct from the restaurant point of sale device a request for an advanced payment that includes a payment amount, a check number, and a user identifier, wherein the point of sale device does not accept direct advance payments;
sending from the advance payment intermediary a request for payment authorization to an advance payment processor, the request includes an authorization amount and the user identifier;
receiving at the advance payment intermediary from the advance payment processor a payment authorization for payment associated with the request;
sending credit card data to the point of sale device from the advance payment intermediary with the payment amount and the check number; and
settling payment from the advance payment processor for the authorization amount from the with the advance payment processor.

10. The method according to claim 9, wherein the payment amount includes a transaction fee.

11. The method according to claim 9, wherein the advance payment comprises an Apple Pay®, Google Pay, Venmo, PayPal, Zelle, Cash App, or crypto currency.

12. The method according to claim 9, wherein the payment authorization from the advanced payment processor is received prior to sending the credit card data to the restaurant point of sale device.

13. The method according to claim 9, further comprising sending an advance payment fee with the payment amount to the point of sale device with the payment amount and the check number.

14. A method at a point of sale device, the method comprising:
receiving a request for payment using an advance payment associated with a bill at a restaurant for a check amount, the request including a user identifier;
sending a request for advance payment to an advance payment intermediary with a check amount and the user identifier
receiving credit card details from the advance payment intermediary for the check amount;
sending the check amount and the credit card details to a credit card processor; and
receiving an indication from the credit card processor that credit card payment has been authorized.

15. The method according to claim 14, wherein the check amount includes an advance payment fee.

16. The method according to claim 14, wherein the advance payment comprises an Apple Pay®, Google Pay, Venmo, PayPal, Zelle, Cash App, or crypto currency.

17. The method according to claim 14, wherein check amount includes a transaction fee.
